(19) United States
(12) Patent Application Publication
(10) Pub. No.: US 2025/0316897 A1
(43) Pub. Date: Oct. 9, 2025

(54) SIGNAL TRANSCEIVER

(71) Applicant: Lite-On Technology Corporation, Taipei (TW)

(72) Inventors: Min Yi Wang, Taipei (TW); Chen Jung Ni, Taipei (TW)

(73) Assignee: Lite-On Technology Corporation, Taipei (TW)

(21) Appl. No.: 19/063,163

(22) Filed: Feb. 25, 2025

Related U.S. Application Data
(60) Provisional application No. 63/573,484, filed on Apr. 3, 2024.

(30) Foreign Application Priority Data
Jan. 13, 2025 (CN) 202520072452.4

(51) Int. Cl. H01Q 1/50; H01Q 1/38

(52) U.S. Cl. CPC H01Q 1/50; H01Q 1/38

(57) ABSTRACT

A signal transceiver includes a circuit board, an electrical connector, and an antenna radiator. The circuit board has a first surface and a second surface opposite to each other. The electrical connector is disposed on the second surface of the circuit board. The antenna radiator includes a radiating body and at least one connecting section. The radiating body is connected to the first surface of the circuit board through the at least one connecting section. A first long-side direction and a first short-side direction of the radiating body respectively correspond to a second long-side direction and a second short-side direction of the circuit board.

### CROSS-REFERENCE TO RELATED APPLICATION

This application claims the priority benefit of U.S. provisional application Ser. No. 63/573,484, filed on Apr. 3, 2024, and China application serial no. 202520072452.4, filed on Jan. 13, 2025. The entirety of each of the above-mentioned patent applications is hereby incorporated by reference herein and made a part of this specification.

### BACKGROUND

### Technical Field

The invention relates to a signal transceiver, and in particular to a signal transceiver for USB Type-C.

### Description of Related Art

Universal Serial Bus (USB) is an industry standard formulated and maintained by the USB Implementers Forum (USB-IF), enabling various functions such as data input/output, charging, and audio and video signal transmission. The standard USB interface, also known as Type-A, includes a plug-in portion with standard cross-sectional dimensions of 12 mm by 4.5 mm, and its depth in the plug-in direction generally exceeds 18 mm due to a circuit board included inside. Therefore, current transceivers adopting USB-A must possess dimensions that are greater than or equal to the ones described above.

In the current USB-A wireless signal transceivers, the circuit board and the plug-in portion are roughly parallel. The antenna is electrically connected to the circuit board, and the antenna and the circuit board are disposed in a housing.

A shift has occurred within the realm of plug-in portions for electronic products towards the adoption of USB Type-C (USB-C). Given the ongoing trend of miniaturization for electronic products, USB-A or large-size signal transceivers no longer adequately fulfill contemporary requirements.

Therefore, the development of a compact signal transceiver having a USB-C interface has emerged as a critical challenge within the industry.

### SUMMARY

The invention provides a signal transceiver, adapted to connect to an electronic device through a USB Type-C interface so as to perform wireless transmission.

A signal transceiver includes a circuit board, an electrical connector, and an antenna radiator. The circuit board has a first surface and a second surface opposite to each other. The electrical connector is disposed on the second surface of the circuit board and has an electrical connection direction. The antenna radiator includes a radiating body and at least one connecting section, and the at least one connecting section extends in the electrical connection direction. The radiating body is connected to the first surface of the circuit board through the at least one connecting section. The radiating body has a first long side and a first short side, and the circuit board has a second long side and a second short side. The length of the first long side is greater than or equal to the length of the first short side, and the length of the second long side is greater than or equal to the length of the second short side. A first long-side direction and a first short-side direction of the radiating body respectively correspond to a second long-side direction and a second short-side direction of the circuit board.

In an embodiment of the invention, the at least one connecting section is bent from the radiating body and extends toward the circuit board in the electrical connection direction, and the electrical connection direction is different from the first long-side direction and the first short-side direction.

In an embodiment of the invention, the first long side of the radiating body extends in the second long-side direction and does not exceed the length of the second long side. The first short side extends in the second short-side direction and does not exceed the length of the second short side. The radiating body is a cuboid-shaped body in this case.

In an embodiment of the invention, the radiating body includes a first radiating portion and a second radiating portion. The first radiating portion is bent back and forth along the first short-side direction. The second radiating portion is connected to the first radiating portion and extends in the first long-side direction and the first short-side direction.

In an embodiment of the invention, the radiating body is a printed radiator. The printed radiator includes a second circuit board and a printed radiation layer. The printed radiation layer is metallic and may be formed on the surface of the second circuit board through processes such as etching, chemical deposition, electroplating, screen printing, intaglio/relief printing, inkjet printing with silver paste, or stamping, etc.

In an embodiment of the invention, the signal transceiver further includes a package body, and the package body covers all the surfaces of the circuit board.

In an embodiment of the invention, the package body further covers the antenna radiator.

In an embodiment of the invention, the package body is made of polymeric material, such as epoxy resin, polyurethane, polyamide, or silicone. The package body may be cured through processes such as standing undisturbed, baking, or other manufacturing procedures, thereby establishing a robust connection between the antenna radiator and the circuit board.

In an embodiment of the invention, the signal transceiver further includes a housing. The housing has an accommodating space, and the circuit board and the antenna radiator are disposed in the accommodating space.

In an embodiment of the invention, the package body may be formed within the housing by means of encapsulation. Alternatively, the package body may be formed by encapsulation or injection molding processes and later combined with the housing.

In an embodiment of the invention, the at least one connecting section includes one connecting section, and the one connecting section includes a feeding end.

In an embodiment of the invention, the at least one connecting section includes two connecting sections, and the two connecting sections include a feeding end and a grounding end, respectively.

In an embodiment of the invention, the at least one connecting section includes three connecting sections, and the three connecting sections include a feeding end, a grounding end, and a positioning end, respectively.

In an embodiment of the invention, the radiating body is parallel to the circuit board.

In an embodiment of the invention, a gap between the radiating body and the circuit board is between 1 mm and 5 mm.

In an embodiment of the invention, the electrical connector is adapted to be docked into an electronic device.

In an embodiment of the invention, the circuit board includes at least one electrical connection spot. The at least one connecting section is fixedly connected to the at least one electrical connection spot.

In an embodiment of the invention, the antenna radiator is formed into one piece.

In an embodiment of the invention, the antenna radiator is capable of generating wireless signals within the ISM (Industrial, Scientific, and Medical) band. The ISM band ranges between 1710 MHz and 7125 MHz, particularly including short-distance and low-power frequency ranges such as between 2400 MHz and 2500 MHz, as well as between 5725 MHz and 5875 MHz.

In an embodiment of the invention, a path length of the antenna radiator is ¼ times a wavelength of a resonance frequency generated by the antenna radiator.

In summary, the signal transceiver in the invention includes a circuit board, an electrical connector, and an antenna radiator. The antenna radiator is connected to the first surface of the circuit board, and the electrical connector is disposed on the second surface of the circuit board. The first long-side direction and the first short-side direction of the radiating body respectively correspond to the second long-side direction and the second short-side direction of the circuit board. The signal transceiver is docked into the interface of an electronic device through the electrical connector and performs wireless signal transmission and reception through the antenna radiator. As a result, the electronic device is able to wirelessly communicate with other devices through the signal transceiver inserted into a USB Type-C interface on the electronic device. In comparison to USB Type-A transceivers, the signal transceiver in this invention exhibits a reduction in interface dimensions and overall size, thereby enhancing compactness and user convenience.

To make the aforementioned more comprehensible, several embodiments accompanied with drawings are described in detail as follows.

### BRIEF DESCRIPTION OF THE DRAWINGS

FIG. 1 is a schematic view of a signal transceiver according to an embodiment of the invention.

FIG. 2 is a schematic view of the signal transceiver of FIG. 1 with the housing removed in another angle of view.

FIG. 3A is a cross-sectional view of the signal transceiver of FIG. 1.

FIG. 3B is a cross-sectional view of a signal transceiver according to another embodiment of the invention.

FIG. 4 is a schematic view of a signal transceiver according to another embodiment of the invention.

FIG. 5 is a schematic view of a signal transceiver according to another embodiment of the invention.

FIG. 6 is a schematic top view of a signal transceiver with the housing removed according to another embodiment of the invention.

### DESCRIPTION OF THE EMBODIMENTS

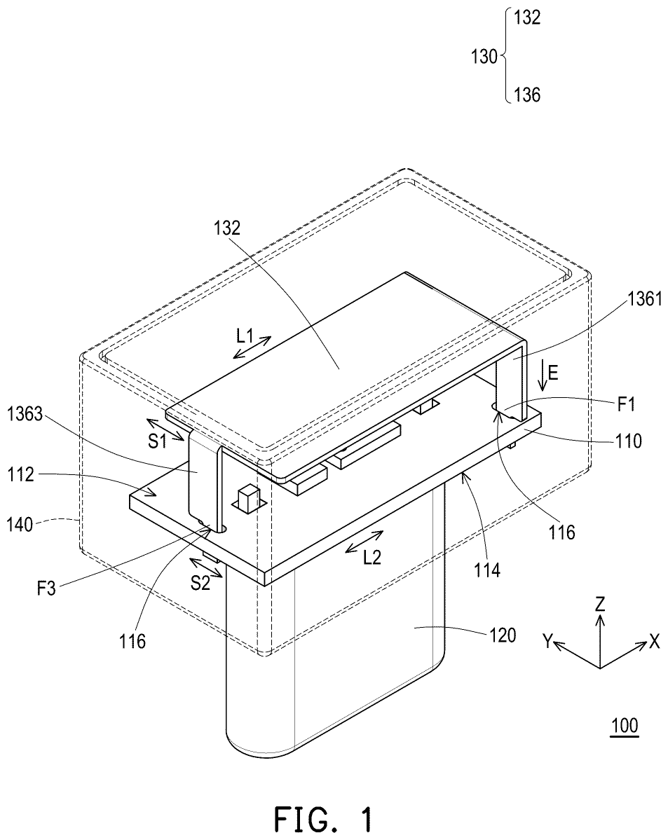

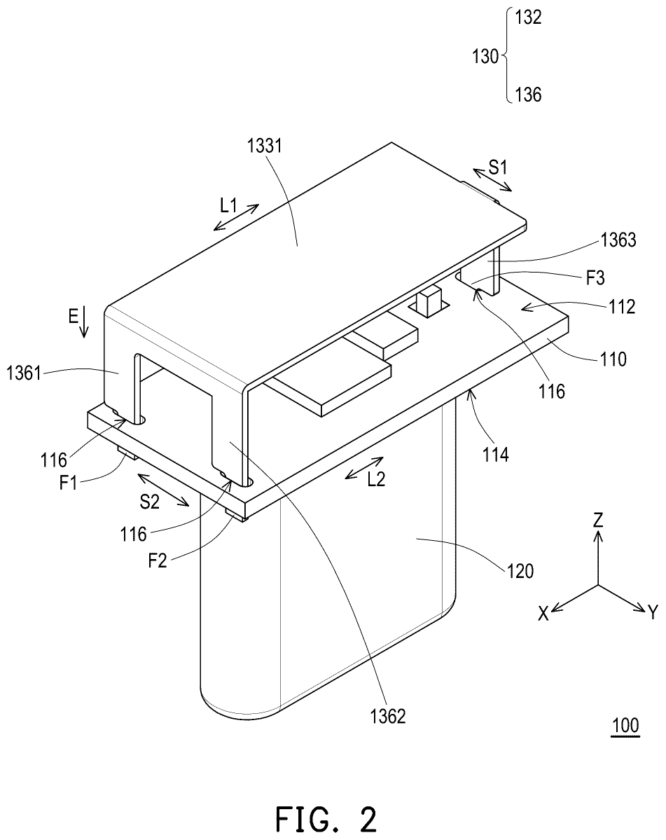

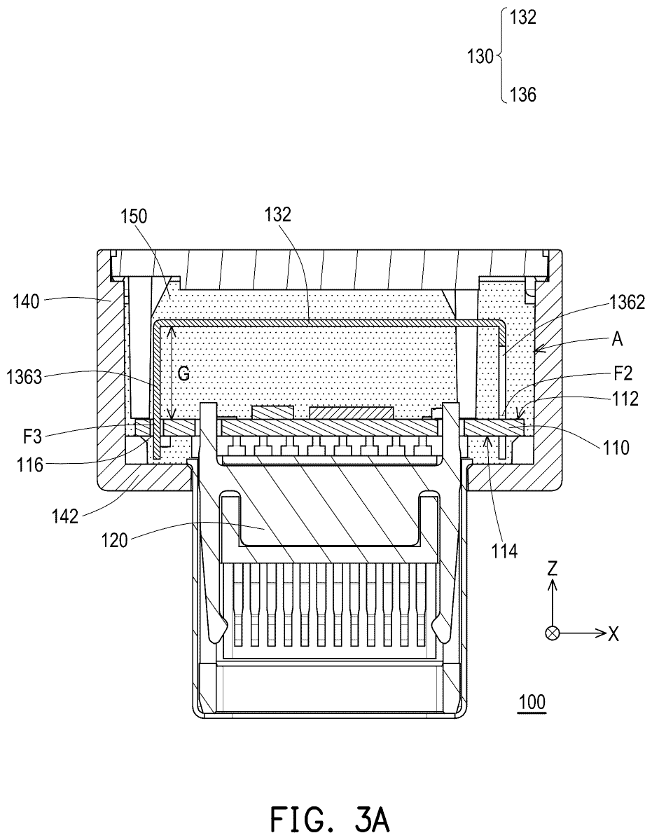

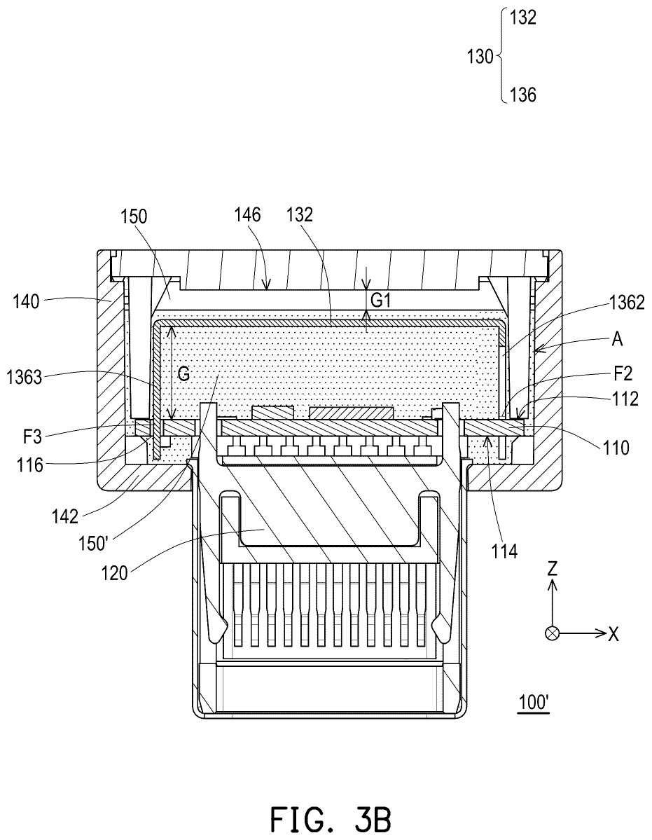

FIG. 1 is a schematic view of a signal transceiver according to an embodiment of the invention. FIG. 2 is a schematic view of the signal transceiver of FIG. 1 with the housing removed in another angle of view. FIG. 3A is a cross-sectional view of the signal transceiver of FIG. 1. The housing is drawn with dotted lines in FIG. 1, so as to clearly demonstrate the internal structure of the signal transceiver. In addition, the package body in FIG. 3A is schematically illustrated with irregular dots.

Referring to FIG. 1 to FIG. 3A, the signal transceiver 100 in this embodiment is adapted to be docked to a USB Type-C interface of an electronic device such as a computer, a laptop, or a mobile phone, and the type of the electronic device to which the signal transceiver 100 is applied is not limited thereto. The electronic device is capable of performing wireless transmission with other devices through the signal transceiver 100, without the need of a physical cable connecting to the USB Type-C interface for transmission, thereby enhancing user convenience and flexibility.

In detail, the signal transceiver 100 includes a circuit board 110, an electrical connector 120, an antenna radiator 130, and a housing 140. The housing 140 has an accommodating space A (FIG. 3A), and the circuit board 110 and antenna radiator 130 are disposed in the accommodating space A. The circuit board 110 is disposed adjacent to a bottom portion 142 of the housing 140 (FIG. 3A) so as to reduce the overall volume of the signal transceiver 100. The circuit board 110 has a first surface 112 and a second surface 114 opposite to each other.

The electrical connector 120 is disposed on the second surface 114 of the circuit board 110 and has an electrical connection direction E. At least one portion of the electrical connector 120 is exposed from the housing 140 and may be connected to the USB Type-C interface of the electronic device such as a computer, a laptop, or a mobile phone in the electrical connection direction E.

The signal transceiver 100 may receive and transmit radio-frequency signals through the antenna radiator 130. Specifically, the antenna radiator 130 includes a radiating body 132 and at least one connecting section 136 connected to each other. The projection of the radiating body 132 on the plane where the circuit board 110 is located is overlapped with the first surface 112 of the circuit board 110. In this embodiment, the at least one connecting section 136 includes three connecting sections 1361, 1362, and 1363. The radiating body 132 is parallel to the circuit board 110 and is connected to the first surface 112 of the circuit board 110 through the connecting sections 1361, 1362, and 1363.

More specifically, the circuit board 110 includes at least one electrical connection spot 116, and the number of the electrical connection spots 116 corresponds to the number of the connecting sections 136 (three electrical connection spots 116 are shown in this embodiment). The connecting sections 1361, 1362, and 1363 are respectively fixed to the corresponding electrical connection spots 116, so as to connect the radiating body 132 to the circuit board 110. The electrical connection spot 116 may be an opening for the connecting sections 1361, 1362, and 1363 to be inserted and fixed. Alternatively, the electrical connection spot 116 may be a metal electrically connected to the circuit board 110 for the connecting sections 1361, 1362, and 1363 to be fixed by welding.

In this embodiment, the connecting sections 1361, 1362, and 1363 include a feeding end F1, a grounding end F2, and a positioning end F3, respectively. The feeding end F1 of the connecting section 1361 may feed a signal to the circuit board 110 or the radiating body 132. The grounding end F2 of the connecting section 1362 is utilized for grounding. The positioning end F3 of the connecting section 1363 provides further positioning and allows the radiating body 132 to be more securely connected to the circuit board 110.

In addition, the connecting sections 1361, 1362, and 1363 in this embodiment are respectively disposed on the sides and/or corners of the circuit board 110, but the locations of the connecting sections 1361, 1362, and 1363 on the circuit board 110 are not limited thereto.

In this embodiment, the radiating body 132 has two first long sides and two first short sides, and the circuit board 110 has two second long sides and two second short sides. The length of the first long side of the radiating body 132 is greater than or equal to the length of the first short side, and the length of the second long side of the circuit board 110 is greater than or equal to the length of the second short side.

A first long-side direction L1 and a first short-side direction S1 of the radiating body 132 respectively correspond to a second long-side direction L2 and a second short-side direction S2 of the circuit board 110. The first long-side direction L1 and the first short-side direction S1 are respectively parallel to the long side and the short side of the radiating body 132, and the second long-side direction L2 and the second short-side direction S2 of the circuit board 110 are respectively parallel to the long side and the short side of the circuit board 110. In this embodiment, the first long-side direction L1 is parallel to the second long-side direction L2 of the circuit board 110, and the first short-side direction S1 is parallel to the second short-side direction S2. In addition, the first long side of the radiating body 132 extends in the second long-side direction L2 but does not exceed the length of the second long side of the circuit board 110, and the first short side of the radiating body 132 extends in the second short-side direction S2 but does not exceed the length of the second short side of circuit board 110.

Moreover, the antenna radiator 130 in this embodiment is formed into one piece. The connecting sections 1361, 1362, and 1363 are bent from the radiating body 132 and extend toward the circuit board 110 in the electrical connection direction E, and a gap G between the radiating body 132 and the circuit board 110 is between 1 mm and 5 mm. The electrical connection direction E is different from the first long-side direction L1 and the first short-side direction S1. In one embodiment, the electrical connection direction E is perpendicular to the first long-side direction L1 and the first short-side direction S1, and that is, the connecting sections 1361, 1362, and 1363 are perpendicular to the circuit board 110.

Through the foregoing design of the bent antenna, the length of the signal transceiver 100 in the electrical connection direction E may be reduced, thereby minimizing the space taken by the signal transceiver 100, which is conducive to device miniaturization.

In this embodiment, the radiating body 132 is a cuboid-shaped printed radiator. The printed radiator has a second circuit board and a printed radiation layer. The printed radiation layer is made of metal and may be formed on the surface of the second circuit board through processes such as etching, chemical deposition, electroplating, screen printing, intaglio/relief printing, inkjet printing with silver paste, or stamping, etc.

The antenna radiator 130 is capable of generating wireless signals within the ISM (Industrial, Scientific, and Medical) band. The ISM band ranges between 1710 MHz and 7125 MHz, particularly including short-range and low-power frequency ranges such as between 2400 MHz and 2500 MHz, as well as between 5725 MHz and 5875 MHz. In one embodiment, the resonance frequency generated by the antenna radiator 130 is approximately 2.4 GHz (with the frequency range of 2400-2480 MHz), and a path length of the antenna radiator 130 is ¼ times the wavelength of the resonant frequency. In another embodiment, the resonance frequency generated by the antenna radiator 130 is approximately 5 GHz.

In addition, as illustrated in FIG. 3A, the signal transceiver 100 in this embodiment further includes a package body 150. The package body 150 may be made of polymeric material, such as epoxy resin, polyurethane, polyamide, or silicone and is disposed in the accommodating space A of the housing 140. In some embodiments, the package body 150 covers all surfaces of the circuit board 110 (including the first surface 112 and the second surface 114). In other embodiments, the package body 150 at least covers the circuit board 110 and the antenna radiator 130. In addition, the package body 150 may be formed within the housing by means of encapsulation. Alternatively, the package body 150 may be formed by encapsulation or injection molding and later combined with the housing 140. In some embodiments, the package body 150 may be cured by baking and allow the antenna radiator 130 to be securely disposed in the housing 140.

FIG. 3B is a cross-sectional view of a signal transceiver according to another embodiment of the invention. A main difference between the embodiment illustrated in FIG. 3B and the embodiment illustrated in FIG. 3A is that the package body 150′ is provided with a different amount.

Specifically, the package body 150′ in this embodiment covers the circuit board 110 and the antenna radiator 130, and there is a gap G1 between the package body 150′ and the top inner wall surface 146 of the housing 140. In other words, the package body 150′ is not completely filled in the accommodating space A, and thus the weight and production cost of the signal transceiver 100′ may be reduced while the package body 150′ still serve to secure the antenna radiator 130.

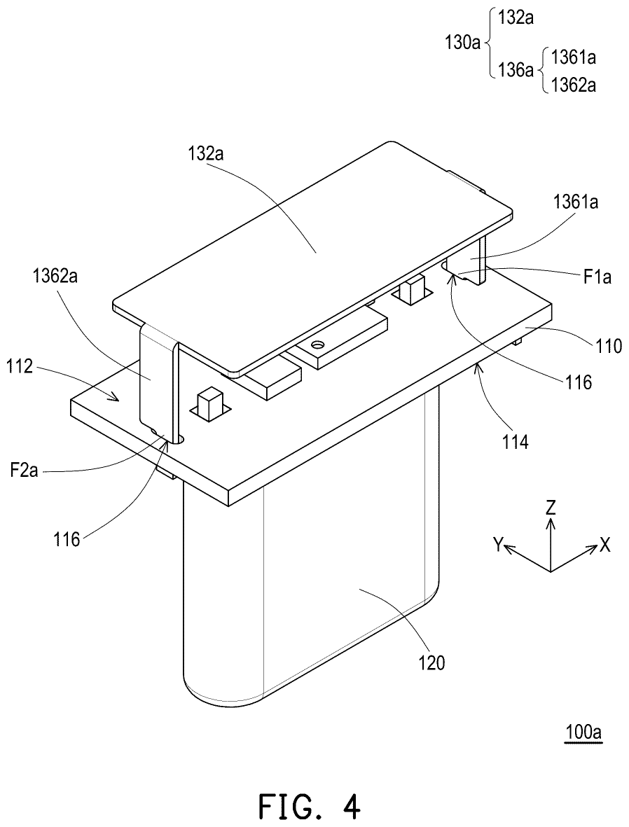

FIG. 4 is a schematic view of a signal transceiver according to another embodiment of the invention. A main difference between the embodiment illustrated in FIG. 4 and the embodiment illustrated in FIG. 1 to FIG. 3A is that two connecting sections 136a (presented as the connecting sections 1361a, 1362a) are provided in the signal transceiver 100a of FIG. 4.

Specifically, the connecting sections 1361a and 1362a, bent from the radiating body 132a of the antenna radiator 130a, are respectively disposed on two opposite sides of the circuit board 110. The connecting section 1361a includes the feeding end Fla, and the connecting section 1362 includes the grounding end F2a. The feeding end Fla functions identically or similarly to the feeding end F1, and the grounding end F2a functions identically or similarly to the grounding end F2. The remaining components and configuration of the signal transceiver 100a are identical or similar to those of the signal transceiver 100 and will not be reiterated here.

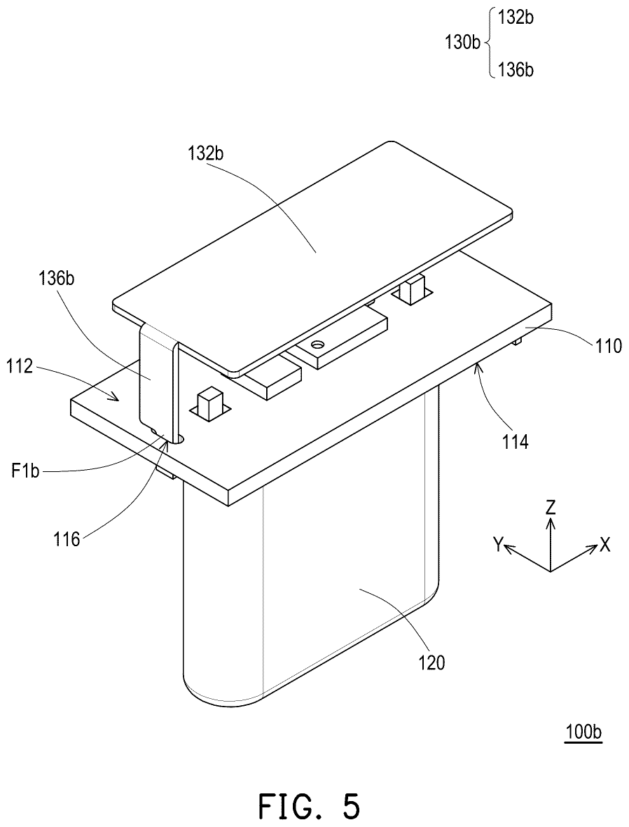

FIG. 5 is a schematic view of a signal transceiver according to another embodiment of the invention. A main difference between the embodiment illustrated in FIG. 5 and the embodiment illustrated in FIG. 1 to FIG. 3A is that only one connecting section 136b is provided in the signal transceiver 100b in FIG. 5.

Specifically, the connecting section 136b, bent from the radiating body 132b of the antenna radiator 130b, is provided on one side of the circuit board 110 and includes the feeding end F1b. The feeding end F1b functions identically and similarly to the feeding end F1. The remaining components and configuration of the signal transceiver 100b are identical or similar to those of the signal transceiver 100 and will not be reiterated here.

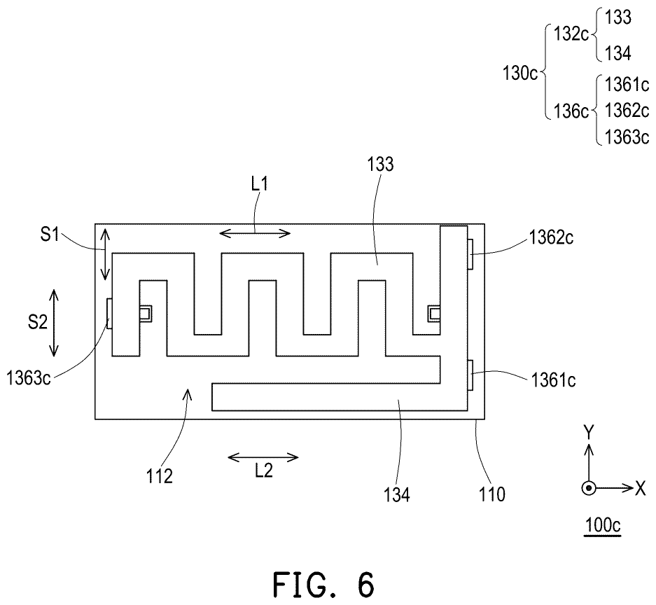

FIG. 6 is a schematic top view of a signal transceiver with the housing removed according to another embodiment of the invention. Some electronic components between the radiating body 132c and the circuit board 110 as well as the package body 150 are omitted and not illustrated. A main difference between the embodiment illustrated in FIG. 6 and the embodiment illustrated in FIG. 1 to FIG. 3A is that the radiating body 132c is not a cuboid-shaped structure in the signal transceiver 100c in FIG. 6.

Specifically, the radiating body 132c in this embodiment is parallel to the circuit board 110 and includes a first radiating portion 133 and a second radiating portion 134. The first radiating portion 133 is connected to one side of the second radiating portion 134 and is bent back and forth along the first short-side direction S1 and extends in the first long-side direction L1. The second radiating portion 134 is, for example, an L-shaped radiator. A portion of the second radiating portion 134 extends in the first long-side direction L1, and the other portion of the second radiating portion 134 extends in the first short-side direction S1. In addition, similar to the embodiment presented in FIG. 1 to FIG. 3A, the at least one connecting section 136c in this embodiment further includes three connecting sections 1361c, 1362c, and 1363c. The connecting section 1363c is connected to an outer side of the first radiating portion 133, and the connecting sections 1361c and 1362c are connected to the other portion of the second radiating portion 134 extending in the first short-side direction S1.

The remaining components and configuration of the signal transceiver 100c are identical or similar to those of the signal transceiver 100 and will not be reiterated here.

In summary, the signal transceiver in this invention includes a circuit board, an electrical connector, and an antenna radiator. The antenna radiator is connected to the first surface of the circuit board, and the electrical connector is disposed on the second surface of the circuit board. The first long-side direction and the first short-side direction of the radiating body respectively correspond to the second long-side direction and the second short-side direction of the circuit board. The signal transceiver is docked into the interface of an electronic device through the electrical connector and performs wireless signal transmission and reception through the antenna radiator. As a result, the electronic device is able to wirelessly communicate with other devices through the signal transceiver inserted into a USB Type-C interface on the electronic device. In comparison to USB Type-A transceivers, the signal transceiver in this invention exhibits a reduction in interface dimensions and overall size, thereby enhancing compactness and user convenience.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A signal transceiver, comprising:
a circuit board, having a first surface and a second surface opposite to each other;
an electrical connector, disposed on the second surface of the circuit board; and
an antenna radiator, comprising a radiating body and at least one connecting section, wherein the radiating body is connected to the first surface of the circuit board through the at least one connecting section, and a first long-side direction and a first short-side direction of the radiating body respectively correspond to a second long-side direction and a second short-side direction of the circuit board.

2. The signal transceiver according to claim 1, wherein the at least one connecting section is bent from the radiating body and extends toward the circuit board in an electrical connection direction, and the electrical connection direction is different from the first long-side direction and the first short-side direction.

3. The signal transceiver according to claim 1, wherein the radiating body comprises a first radiating portion and a second radiating portion, the first radiating portion is bent back and forth along the first short-side direction, and the second radiating portion is connected to the first radiating portion and extends in the first long-side direction and the first short-side direction.

4. The signal transceiver according to claim 1, wherein the radiating body is cuboid-shaped.

5. The signal transceiver according to claim 1, wherein the radiating body is a metal antenna.

6. The signal transceiver according to claim 1, further comprising a package body, wherein the package body at least covers the circuit board and the antenna radiator.

7. The signal transceiver according to claim 1, further comprising a housing, wherein the housing has an accommodating space, and the circuit board and the antenna radiator are disposed in the accommodating space.

8. The signal transceiver according to claim 1, wherein the at least one connecting section comprises one connecting section, and the one connecting section comprises a feeding end.

9. The signal transceiver according to claim 1, wherein the at least one connecting section comprises two connecting sections, and the two connecting sections comprise a feeding end and a grounding end, respectively.

10. The signal transceiver according to claim 1, wherein the at least one connecting section comprises three connecting sections, and the three connecting sections comprise a feeding end, a grounding end, and a positioning end, respectively.

11. The signal transceiver according to claim 1, wherein the radiating body is parallel to the circuit board.

12. The signal transceiver according to claim 1, wherein a gap between the radiating body and the circuit board is between 1 mm and 5 mm.

13. The signal transceiver according to claim 1, wherein the electrical connector is adapted to be docked into an electronic device.

14. The signal transceiver according to claim 1, wherein the circuit board comprises at least one electrical connection spot, and the at least one connecting section is fixedly connected to the at least one electrical connection spot.

15. The signal transceiver according to claim 1, wherein the antenna radiator is formed into one piece.

16. The signal transceiver according to claim 1, wherein a resonance frequency generated by the antenna radiator is approximately 2.4 GHz.

17. The signal transceiver according to claim 1, wherein a resonance frequency generated by the antenna radiator is approximately 5 GHz.

18. The signal transceiver according to claim 1, wherein a path length of the antenna radiator is ¼ times a wavelength of a resonance frequency generated by the antenna radiator.
